(19) United States
(12) Patent Application Publication
(10) Pub. No.: US 2021/0310654 A1
(43) Pub. Date: Oct. 7, 2021

(54) THERMAL POWER STATION EXHAUST GAS PROCESSING DEVICE

(71) Applicant: EMKO CO., LTD., Seoul (KR)

(72) Inventors: Han-Jae JO, Hwaseong-si Gyeonggi-do (KR); Seung-Jae LEE, Seoul (KR)

(21) Appl. No.: 17/264,560

(22) PCT Filed: Sep. 3, 2019
(86) PCT No.: PCT/KR2019/011349

§ 371 Date: Jan. 29, 2021

(30) Foreign Application Priority Data
Sep. 7, 2018 (KR) 10-2018-0107300

(51) Int. Cl. F23J 15/00; F01D 25/30

(52) U.S. Cl. CPC F23J 15/003; F01D 15/10; F23J 15/006; F01D 25/305

(57) ABSTRACT

Proposed is an exhaust gas processing device for a thermal power station. The exhaust gas processing device includes: a diffusion module portion configured to adjust an exhaust gas flow, between a duct disposed on a rear end of a gas turbine of a thermal power station and the gas turbine, thereby inducing same toward an inner wall of the duct; a plurality of spray nozzles installed in a flow section, inside the duct, of an exhaust gas induced from the diffusion module portion toward the inner wall of the duct and protruding formed from the inner wall of the duct; a fluid supply pipe connected to the spray nozzles and being extended to the outside of the duct; and a fluid supply portion configured to supply liquid-phase contaminant processing fluid to the spray nozzles through the fluid supply pipe.

### TECHNICAL FIELD

The present disclosure relates to an exhaust gas processing device and, more particularly, to an exhaust gas processing device for a thermal power station.

### BACKGROUND ART

Electricity is generally produced in large-scale power generation facilities. In power stations, power generation is mainly accomplished by methods to generate power such as thermal power generation generated by combusting fuel, nuclear power generation by using nuclear energy, hydroelectric power generation by using head drops, and the like, and in other power generation facilities, other methods by using solar heat, tidal power, wind power, and the like are also used.

Among the above-mentioned generation methods, the thermal power generation method is a method of driving a turbine by combusting fuel as a power generation method that is still used very actively. In order to obtain power from thermal power generation, fuel should be continuously consumed. Such fuel is combusted in the gas turbine and generates a large amount of exhaust gases. Such exhaust gases contain contaminants generated by combustion reactions and high-temperature thermal reactions of the fuels, and thus special processing is required.

Therefore, various types of exhaust gas processing facilities are applied to thermal power stations (e.g., Korean Patent No. 10-1563079, and the like), but exhaust gas is not satisfactorily processed with conventional processing facilities. In particular, in thermal power stations, the operation state of the turbine changes from time to time, and the conditions such as the flow rate, speed, and temperature of the exhaust gas may change accordingly. In particular, the conditions may rapidly change during starting up, so a technical response to this is required, but the development of satisfactory processing technology is still in a state that requires further development.

### DOCUMENTS OF RELATED ART

### Patent Document

(Patent Document 1) Korean Patent No. 10-1563079 (Oct. 30, 2015)

### DISCLOSURE

### Technical Problem

Accordingly, the present disclosure has been made keeping in mind the above problems occurring in the related art. Here, an objective of the present disclosure is to provide an exhaust gas processing device for a thermal power station, specifically, to provide an exhaust gas processing device of a thermal power station that can efficiently process exhaust gas even during starting up of the thermal power station.

The objective of the present disclosure is not limited to solve the problems mentioned above, and other technical problems that are not mentioned will be clearly understood by those skilled in the art from the following description.

### Technical Solution

In order to accomplish the above objective, the present disclosure may provide an exhaust gas processing device for a thermal power station, the exhaust gas processing device including: a diffusion module portion configured to adjust an exhaust gas flow, between a duct disposed on a rear end of a gas turbine of a thermal power station and the gas turbine, thereby inducing same toward an inner wall of the duct; a plurality of spray nozzles installed in a flow section, inside the duct, of an exhaust gas induced from the diffusion module portion toward the inner wall of the duct and protrudingly formed from the inner wall of the duct; a fluid supply pipe connected to the spray nozzles and being extended to the outside of the duct; and a fluid supply portion configured to supply liquid-phase contaminant processing fluid to the spray nozzles through the fluid supply pipe, wherein the diffusion module portion comprises: an outer cylinder portion configured such that the exhaust gas passes through the interior thereof; and a hub inserted into a center portion of the outer cylinder portion so as to induce the exhaust gas in a centrifugal direction, and the spray nozzles do not intersect with an extension line extending in a longitudinal direction of the hub from an outer circumferential surface of the hub.

Each of the spray nozzles may be coupled penetrating through the duct and have one end portion located inside the duct and an opposite end portion exposed to the outside of the duct.

Each of the spray nozzles may be inserted into the inside of a flanged pipe penetrating through the duct and having a flange formed at the outside of the duct, and may be fixed by being in contact with the flange at at least a part thereof.

The fluid supply pipe may be connected to the opposite end portion of each of the spray nozzles, exposed to the outside of the duct.

The duct may be a polygonal duct having a cross section in a polygonal shape formed by connecting different inner walls in a planar shape from which the spray nozzles may protrude.

The spray nozzles may be arranged such that at least one thereof may be on each of a plurality of different inner walls of the duct.

The exhaust gas processing device for a thermal power station may further include a flow control member configured to induce a flow direction of the exhaust gas toward the inner wall of the duct at the hub.

One end portion of each of the spray nozzles may be spaced apart by no more than ⅚ of a length of a vertical line ‘a’ from the inner wall of the duct, along the vertical line ‘a’, wherein the vertical line ‘a’ is drawn downwards from an extension line to the inner wall of the duct, wherein the extension line is parallelly extended from an outer circumferential surface of the hub in the longitudinal direction of the hub.

Each of the spray nozzles may be spaced apart from an intersection of a first extension line and a second extension line, along the first extension line, by no more than ⅞ of a straight-line distance ‘c’, wherein the first extension line parallelly extends in a longitudinal direction of the duct on the inner wall of the duct, the second extension line extends from a right end of the hub and perpendicularly intersects with the first extension line, and the straight-line distance ‘c’ is a length from the hub to the duct expansion pipe connected to a rear end of the duct.

The duct may include a buffer connection portion, configured to buffer a vibration, on one side, and the spray nozzles may be located at a rear end of the buffer connection portion.

Each of the spray nozzles may include: a fluid transporting path connected to a fluid discharge port and configured to transport the contaminant processing fluid; and a heat insulating flow path not connected to the fluid discharge port, surrounding the fluid transporting path, and configured to accommodate a heat insulation fluid.

Each of the spray nozzles may further include a pressurized gas flow path connected to the fluid discharge port and configured to transport a pressurized gas.

### Advantageous Effects

As described above, according to the present disclosure, an exhaust gas of a thermal power station can be processed very effectively and efficiently. In particular, it is possible to process the exhaust gas simply and conveniently. Further, the present disclosure can exhibit an excellent processing effect, in particular, for the exhaust gas generated and discharged from a combined cycle power station and can exhibit an excellent processing effect even during starting up of the combined cycle power station.

### DESCRIPTION OF DRAWINGS

FIG. 1 is a diagram showing an arrangement structure of an exhaust gas processing device for a thermal power station according to an embodiment of the present disclosure.

FIG. 2 is a sectional view taken along line A-A′ of a duct portion in which spray nozzles of the exhaust gas processing device of FIG. 1 are installed.

FIG. 3 is enlarged views showing an installation structure of each of the spray nozzles of FIG. 2.

FIG. 4 is a partially enlarged view showing an enlarged portion of the arrangement structure of FIG. 1.

FIGS. 5 to 7 are sectional views illustrating an internal structure of each of the spray nozzles of FIG. 4.

FIG. 8 is a view showing an example of a flow control member formed in a hub.

FIG. 9 is an operation diagram of the exhaust gas processing device of FIG. 1.

### MODE FOR INVENTION

Advantages and features of the present disclosure and methods of achieving same will be apparent with reference to embodiments described below in detail together with accompanying drawings. However, the present disclosure is not limited to the embodiments disclosed below but may be implemented in a variety of different forms. In addition, the present embodiments are provided to allow the present disclosure to be complete and are provided to completely inform the scope of the disclosure to those of ordinary skill in the art to which the present disclosure belongs, and the present disclosure is only defined by the claims. Meanwhile, the same reference numerals refer to the same elements throughout the specification.

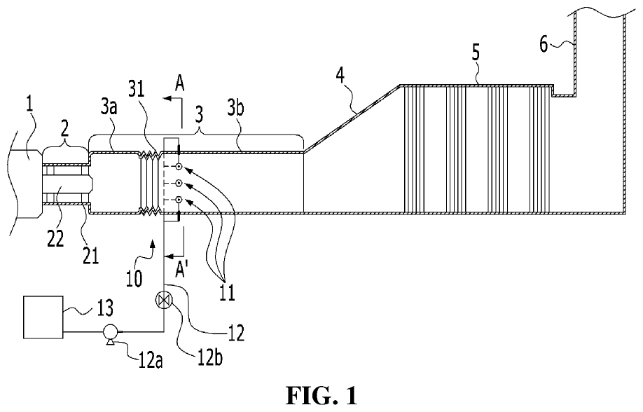

Hereinafter, an exhaust gas processing device for a thermal power station (hereinafter, an exhaust gas processing device) according to an embodiment of the present disclosure will be described in detail with reference to FIGS. 1 to 9.

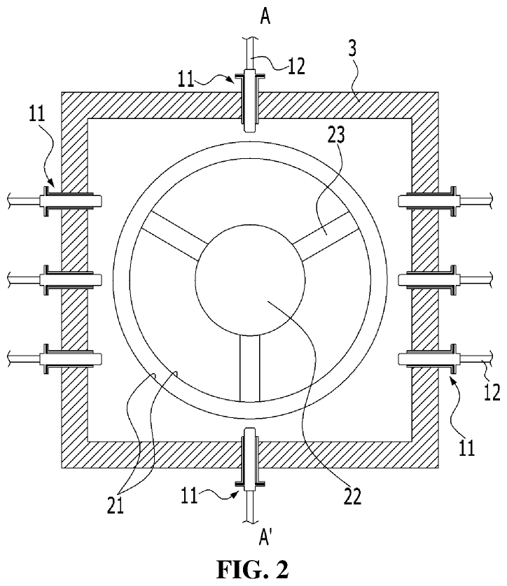

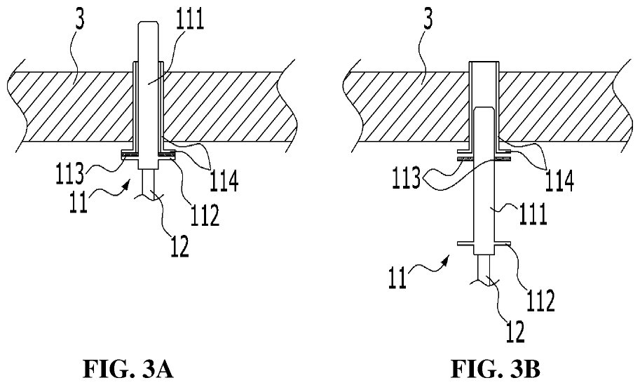

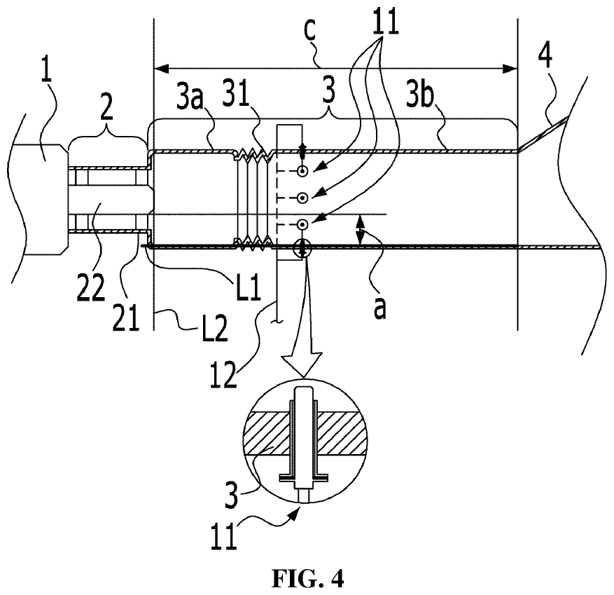

FIG. 1 is a diagram showing an arrangement structure of an exhaust gas processing device for a thermal power station according to an embodiment of the present disclosure, FIG. 2 is a sectional view taken along line A-A′ of a duct portion in which spray nozzles of the exhaust gas processing device of FIG. 1 are installed, FIG. 3 is enlarged views showing an installation structure of each of the spray nozzles of FIG. 2, and FIG. 4 is a partially enlarged view showing an enlarged portion of the arrangement structure of FIG. 1.

With reference to FIGS. 1 to 4, an exhaust gas processing device 10 of the present disclosure is configured to effectively process an exhaust gas using the exhaust gas flow of the thermal power station. The exhaust gas processing device 10 of the present disclosure is formed to induce the exhaust gas flow toward an inner wall of a duct 3 through a diffusion module portion 2 connected to a gas turbine 1. The spray nozzles 11 do not require a grid-like structure installed inside the space, where the exhaust gas flows, and protrudes directly from the inner wall of the duct 3, thereby allowing contaminant processing fluid to be easily injected into the exhaust gas without disturbing the exhaust gas flow in the duct 3.

In particular, an area, having the spray nozzles 11 disposed therein, of the inner wall of the duct 3 is a region, in which the exhaust gas flow induced by the diffusion module portion 2 in a centrifugal direction is formed and maintained and the exhaust gas is distributed relatively highly in the duct 3. Therefore, by intensively injecting the contaminant processing fluid in the exhaust gas to the spray nozzles 11 disposed in this area, it is possible to more effectively process contaminants in the exhaust gas. In this way, the processing efficiency of the entire exhaust gas may be significantly increased by processing the exhaust gas by intensively spraying the contaminant processing fluid at a specific point in consideration of the exhaust gas flow.

Such a processing structure may exert a very excellent processing effect by intensively injecting the contaminant processing fluid into the exhaust gas whose temperature has not yet sufficiently risen during starting up point of the gas turbine 1 so may be applied particularly effectively to combined cycle power stations in which an operational situation of the gas turbine 1 is changed from time to time and started up relatively frequently. That is, an exhaust gas to be processed by the present disclosure may be the exhaust gas of the combined cycle power station, and the present disclosure may be particularly useful for processing exhaust gas generated at the time when the gas turbine 1 of the combined cycle power station is started up. In particular, a yellow gas-causing substance, which is conventionally contained in the exhaust gas and produce a yellow gas, in an initial period of such starting up may also be processed very effectively using the processing structure of the present disclosure, so the present disclosure may be very useful for removing the yellow gas of the combined cycle power station.

The exhaust gas processing device 10 according to an embodiment of the present disclosure is specifically configured as follows. The exhaust gas processing device 10 includes: a diffusion module portion 2 configured to adjust an exhaust gas flow, between a duct 3 disposed on a rear end of a gas turbine 1 of a thermal power station and the gas turbine 1, thereby inducing same toward the inner wall of the duct 3; a plurality of spray nozzles 11 installed in a flow section, inside the duct 3, of the exhaust gas induced, from the diffusion module portion 2 toward the inner wall of the duct 3 and protrudingly formed from the inner wall of the duct 3; a fluid supply pipe 12 connected to the spray nozzles 11 and being extended to the outside of the duct; and a fluid supply portion 13 configured to supply liquid-phase contaminant processing fluid to the spray nozzles 11 through the fluid supply pipe 12. Hereinafter, a specific arrangement structure of the exhaust gas processing device 10 and features of each component will be described in more detail with reference to each drawing.

First, an arrangement relationship between an exhausting structure for the exhaust gas, wherein the structure is composed of the gas turbine 1, the duct 3, a duct expansion pipe 4, and a stack 6, and the diffusion module portion 2 will be described. Hereinafter, a front end and a rear end are relative positions with respect to the exhaust gas proceeding direction, and in FIG. 1, the exhaust gas proceeds to the right in the horizontal direction, so a right end side direction may be the rear end. Describing in detail with reference to FIG. 1, the gas turbine 1 combusts fuel to rotate the turbine and discharges the exhaust gas generated during combustion to the rear end. The duct 3 is disposed at the rear end of the gas turbine 1. Here, the duct 3 is disposed at the rear end of the gas turbine 1 but may not be directly connected to the gas turbine 1. The diffusion module portion 2 may be formed between the gas turbine 1 and the duct 3. The diffusion module unit 2 may introduce the exhaust gas discharged from the gas turbine 1 and regulate the pressure of the gas, and diffuse and discharge the gas to the duct 3. The diffusion module portion 2 allows the exhaust gas to be passed and may add a centrifugal velocity component to the exhaust gas. Thus, the exhaust gas may be induced toward the inner wall of the duct 3 at the rear end of the diffusion module portion 2.

The duct expansion 4 is connected to the rear end of the duct 3 again. The duct expansion pipe 4 is a funnel-shaped structure whose width is gradually increased and is connected to a heat recovery boiler portion 5, at the rear end thereof. The heat recovery boiler portion 5 includes an exhaust gas flow passage that is wider than that of the duct 3 and may be installed therein with a superheater or the like for recovering the heat energy of the exhaust gas and amplifying the recovered heat energy. To the rear end of the heat recovery boiler portion 5, the stack 6 extending in the vertical direction is connected, so that the exhaust gas is finally discharged through the stack 6.

The spray nozzles 11 are installed in the flow section, inside the duct 3, of the exhaust gas induced, from the diffusion module portion 2 toward the inner wall of the duct 3. As described above, the diffusion module portion 2 introduces the exhaust gas and regulates the pressure of the gas and diffuses and discharges the gas. In this process, the exhaust gas obtains a velocity component in the centrifugal direction and is induced toward the inner wall of the duct 3 located at the rear end of the diffusion module portion 2. Since the spray nozzles 11 are formed directly protruding from the inner wall of the duct 3, the contaminant processing fluid may be processed by being directly injected into the high-concentration exhaust gas flow formed by being induced toward the inner wall of the duct 3 as described above. The flow section refers to a space in which the exhaust gas induced toward the inner wall of the duct 3 by the diffusion module portion 2 flows. However, the flow section is not limited as described above and may be a space formed between the extension line, which parallelly extends from an outer circumferential surface of a hub 22, to be described later, in a longitudinal direction of the hub 22, and the inner wall of the duct 3. Furthermore, the flow section may refer to a space that is: spaced apart by no more than ⅚ of a length of a vertical line ‘a’ from the inner wall of the duct 3, along the vertical line ‘a’ (refer to FIG. 4), wherein the vertical line ‘a’ is drawn downwards from an extension line to the inner wall of the duct 3, wherein the extension line is parallelly extended from an outer circumferential surface of the hub 22 in the longitudinal direction of the hub 22; and spaced apart, from an intersection of a first extension line (refer to L1 in FIG. 4) and a second extension line (refer to L2 in FIG. 4), along the first extension line, by no more than ⅞ of the straight-line distance ‘c’ (refer to FIG. 4), wherein the first extension line parallelly extends in a longitudinal direction of the duct 3 on the inner wall of the duct 3, the second extension line extends from a right end of the hub 22 and perpendicularly intersects with the first extension line, and the straight-line distance ‘c’ is a length from the hub to the duct expansion pipe connected to the rear end of the duct.

The diffusion module portion 2 has a structure including an outer cylinder portion 21 through which the exhaust gas passes and the hub 22 that is inserted into a center portion of the outer cylinder portion 21 to induce the exhaust gas in the centrifugal direction so that it is possible to more easily form the exhaust gas flow induced toward the inner wall of the duct 3. The outer cylinder portion 21 may have a circular cross section. The hub 22 in the center portion of the outer cylinder portion 21 functions as a kind of resistance to the exhaust gas and changes the flow direction of the exhaust gas towards the outer side of the hub 22, so that a larger velocity component in the centrifugal direction in the exhaust gas may be added. The length, diameter, or the like of the hub 22 may be changed as necessary. The hub 22 may be connected and fixed to the outer cylinder portion 21 with supports 23.

The duct 3 may be formed of a pipe between the diffusion module portion 2 and the duct expansion pipe 4 and may include a buffer connection portion 31, configured to buffer a vibration, on one side. The spray nozzles 11 may be located at a rear end of the buffer connection portion 31. For example, the duct 3 may be a structure composed of a first duct portion 3a, a second duct portion 3b, and the buffer connection portion 31 between the first duct portion 3a and the second duct portion 3b as shown, wherein the buffer connection portion 31 may be a structure formed to absorb the vibration and to prevent the propagation of the vibration to the rear end. Since the spray nozzles 11 are located at the rear end of such buffer connection portion 31, the spray nozzles 11 may inject the contaminant processing fluid into the exhaust gas more smoothly at a normal position while minimizing the influence due to the mechanical vibration and the like of the gas turbine 1. However, it is not necessarily limited as such, and when necessary, the spray nozzles 11 may be installed at any position in the duct 3 regardless of the front end or the rear end of the buffer connection portion 31. However, in the present embodiment, an example that the spray nozzles 11 are disposed at the rear end of the buffer connection portion 31 is described, but it is not necessarily limited thereto. The buffer connection portion 31 may include various types of shock absorbers and may include a structure such as a corrugated pipe such as bellows that absorbs vibrations. Sizes of the first duct portion 3a and the second duct portion 3b are not determined, and the size or arrangement state of same may be appropriately changed according to the position or arrangement state of the buffer connection portion 31. For example, by moving and disposing the buffer connection portion 31 closer to the gas turbine 1, a length of the first duct portion 3a may be shorter than that of the second duct portion 3b.

The fluid supply pipe 12 is connected to the spray nozzles 11 and extends outside the duct 3. The fluid supply pipe 12 may be structured in various forms capable of supplying the contaminant processing fluid from a fluid supply structure outside the duct 3 to the spray nozzles 11 coupled to the duct 3. Therefore, since the formation method of the fluid supply pipe 12 as shown is exemplary, it is not necessary to limitedly understand the shape of the fluid supply pipe 12 as such. A fluid control structure including a pump 12a configured to flow a fluid and a control valve 12b configured to control the inflow and outflow of the fluid supply pipe 12 may also be formed in various forms. For example, the pump 12a may include a metering pump capable of metering injection, and the control valve 12b may be formed by combining one or more valve structures of various types, such as a shut-off valve capable of controlling inflow and outflow, a check valve preventing backflow, a pressure regulating valve (PRV) capable of controlling pressure, and the like. It is also possible to additionally install valves. In addition, the position of the valve may be changed as necessary, so that the valves may be installed as many as needed at the main pipe introducing the fluid, the branch pipe branching to each spray nozzle 11, or the like.

The fluid supply portion 13 supplies the liquid-phase contaminant processing fluid to the spray nozzles 11 through the fluid supply pipe 12. The fluid supply portion 13 may be a storage place configured to store the contaminant processing fluid and may include, for example, a structure such as a fluid storage tank. The liquid-phase contaminant processing fluid may be stored in the fluid supply portion 13 and supplied to the fluid supply pipe 12. The contaminant processing fluid may be a material capable of processing various contaminants (for example, nitrogen oxides, sulfur oxides, and the like) in the exhaust gas. The material may vary depending on the type of contaminant, and the material may be a single material or a mixture of one or more materials. By spraying the contaminant processing fluid through the spray nozzles 11 protruding from the inner wall of the duct 3, the exhaust gas induced toward the inner wall of the duct 3 may be more effectively injected.

The contaminant processing fluid may be, for example, a liquid-reducing agent that reduces nitrogen oxides in the exhaust gas and, in particular, may be one that reduces a yellow gas-causing substance such as nitrogen dioxide, which may be generated during the starting up of the gas turbine 1 and contained in the exhaust gas, and processes the yellow gas-causing substance. The contaminant processing fluid may be, for example, a non-nitrogen-based reducing agent, and may be one capable of reducing yellow gas by processing through reducing nitrogen dioxide to nitrogen monoxide. The contaminant processing fluid may be at least one selected from hydrocarbons, oxygenated hydrocarbons, and carbohydrates, each of which includes at least one of hydroxyl (OH) groups, ether groups, aldehyde groups, or ketone groups in one molecule, and may be liquid. Furthermore, the contaminant processing fluid may be at least one selected from ethanol, ethylene glycol, and glycerin, and may be liquid. However, it is not necessary to be limited as described above, and the contaminant processing fluid may even include a nitrogen-based reducing agent such as ammonia depending on the situation.

The spray nozzles 11 are coupled penetrating through the duct 3 as shown in FIG. 2. One end portion of each of the spray nozzles 11 may be located inside the duct 3 and an opposite end portion of same may be exposed to the outside of the duct 3. That is, the spray nozzles 11 may be installed in a very simple manner by penetrating through the duct 3 without the aid of a structure that obstructs the exhaust gas flow inside the duct 3 as described above. The fluid supply pipe 12 configured to supply the contaminant processing fluid may be connected to the opposite end portion, exposed to the outside of the duct 3, of the spray nozzles 11.

Each of the spray nozzles 11 may be installed very conveniently in a structure as shown in FIG. 3. For example, each of the spray nozzles 11 is inserted into the inside of a flanged pipe 114 penetrating through the duct 3 and having a flange formed at the outside of the duct 3, and may be fixed by being in contact with the flange at at least a part thereof. For example, a coupling flange 112 is protrudingly formed around a body 111 of each of the spray nozzles 11, and each of the spray nozzles 11 may be fixed by bringing the coupling flange 112 into contact with the flange (a bent part, formed at the outside of the duct 3, of the flanged pipe 114 of FIG. 3) of the flanged pipe 114. At this time, instead of allowing the flange of the coupling flange 112 and the flanged pipe 114 to be in direct contact, a structure capable of closing a gap and buffering an impact may be formed by inserting a gasket 113 into the gap therebetween. Through such a structure, each of the spray nozzles 11 may be inserted into and very conveniently fixed to the flanged pipe 114 as shown in FIG. 3(a) and may be very conveniently separated by being drawn out from the flanged pipe 114 as shown in FIG. 3(b). When fixing each of the spray nozzles 11, for example, a removable coupling member (not shown) such as a bolt or a nut may be used, and in addition, it is possible to increase the fixability by forming a structure such as a projection and a groove. The spray nozzles 11 may be very conveniently installed to the duct 3 with such a structure.

The duct 3 may be a polygonal duct having a cross section in a polygonal shape formed by connecting different inner walls, of a planar shape, from which the each of the spray nozzles 11 protrudes. However, it is not necessarily limited as such, and the duct 3 may be formed in a shape having even a circular cross section. However, in the present embodiment, a case of a polygonal duct is described as an example, and in such a case, the following features may be additionally provided. However, since the present embodiment is only an example, the shape of the duct 3 in other embodiments may be changed to as many numbers of other shapes as needed. The duct 3 may have a width wider than a maximum diameter of the outer cylinder portion 21 having a circular cross section. For example, as shown in FIG. 2, the duct 3 may be formed as a quadrilateral duct whose width is wider than the maximum diameter of the outer cylinder portion 21. At least one spray nozzle 11 may be arranged on each of a plurality of different inner walls of the duct 3. However, the shape of the duct 3 need not be limited to the illustrated shape, and the arrangement of the spray nozzles 11 need not also be limited as shown. A duct 3 having a polygonal shape other than a quadrilateral square shape is also possible as necessary, and the arrangement of the spray nozzles 11 may be changed as much as possible according to the shape or arrangement of the duct 3. For example, the spray nozzle 11 may be allowed to appropriately change the number of the nozzles installed on each of the different inner walls or spacing between adjacent nozzles in consideration of the distribution of the flow velocity of the exhaust gas.

The spray nozzles 11 may be formed so as not to overlap with the hub 22 in a direction facing the hub 22 as shown in FIG. 2. That is, as described above, the diffusion module portion 2 includes the hub 22 inserted into the center portion of the outer cylinder unit 21, and the spray nozzles 11 may not intersect with the extension line extending in the longitudinal direction of the hub 22 from the outer circumferential surface of the hub 22 (see FIG. 4). Hereinafter, the arrangement structure of the spray nozzles 11 will be described in more detail with reference to FIG. 4.

With reference to FIG. 4, the one end portion of each of the spray nozzles 11 may be spaced apart by no more than ⅚ of the length of the vertical line ‘a’ from the inner wall of the duct 3, along the vertical line ‘a’, wherein the vertical line ‘a’ is drawn downwards from an extension line to the inner wall of the duct 3, wherein the extension line is parallelly extended from an outer circumferential surface of the hub 22 in the longitudinal direction of the hub 22. By setting a position of the one end portion of each of the spray nozzles 11 in such a range, it is possible to more accurately position the one end portion of each of the spray nozzles 11 on the exhaust gas flow induced toward the inner wall of the duct 3, and thus it is possible to more effectively inject and mix the contaminant processing fluid into the exhaust gas flow induced inside the duct 3. This is confirmed from an experimental example. As described above, the arrangement of the spray nozzles 11 is made within a limit of not intersecting with the extension line extending in the longitudinal direction of the hub 22 from the outer circumferential surface of the hub 22, and the position of the one end portion of each of the spray nozzles 11 may be appropriately adjusted within the above-stated range.

In addition, the spray nozzles 11 may be spaced apart from the intersection of the first extension line and the second extension line, along the first extension line, by no more than ⅞ of the straight-line distance ‘c’, wherein the first extension line parallelly extends in the longitudinal direction of the duct 3 on the inner wall of the duct 3, the second extension line extends from the right end of the hub 22 and perpendicularly intersects with the first extension line, and the straight-line distance ‘c’ is a length from the hub to the duct expansion pipe connected to the rear end of the duct. The position of each of the spray nozzles 11 may be appropriately adjusted within the above-described range within the limit being positioned within the duct 3. That is, each of the spray nozzles 11 may be allowed to adjust not only the position of the one end portion but also an installation position thereof entirely. Within the above range, it is possible to more effectively inject and mix the contaminant processing fluid into the exhaust gas flow induced into the duct 3, and this is also confirmed from the experimental example. The experimental example will be described later in detail.

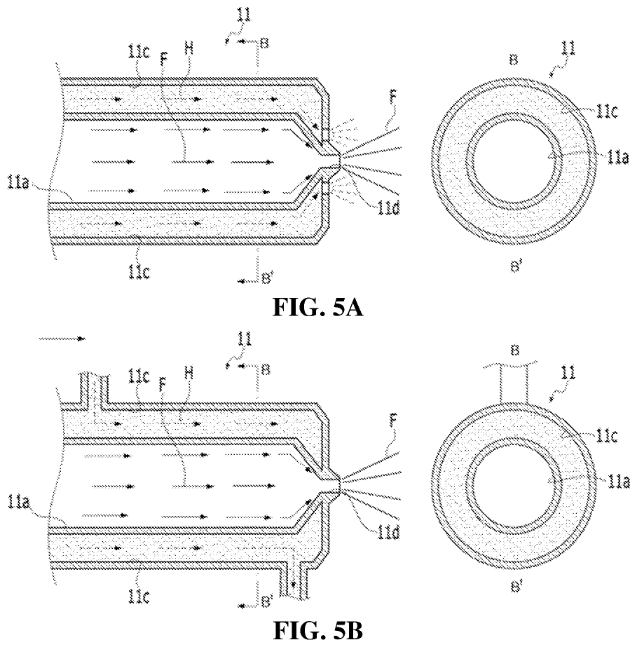

Hereinafter, an internal structure of each of the spray nozzles will be described in more detail with reference to FIGS. 5 to 7. FIGS. 5 to 7 are sectional views illustrating an internal structure of each of the spray nozzles of FIG. 4. Each sectional view shows the one end portion of each of the spray nozzles formed with a fluid discharge port. In each example of the drawings, a longitudinal sectional view on the left side and a sectional view on the right side are arranged together to facilitate identification of the flow path structure.

Each of the spray nozzles 11 may have therein a flow path structure as shown in FIGS. 5 to 7. Each of the spray nozzles 11 may include: a fluid transporting path 11a connected to a fluid discharge port 11d of the one end portion and configured to transport the contaminant processing fluid F; and a heat insulating flow path 11c not connected to the fluid discharge port 11d, surrounding the fluid transporting path 11a, and accommodating a heat insulation fluid H. Therefore, the contaminant processing fluid F is not vaporized by the high heat of the exhaust gas due to the thermal insulation action of the heat insulating flow path 11c, and be safely moved to and discharged into each of the spray nozzles 11. Hereinafter, an example of such a flow path structure will be described in more detail.

Each of the spray nozzles 11 may be formed, for example, as shown in FIGS. 5(a) and 5(b). Each of the spray nozzles 11 may include: the fluid transporting path 11a configured to allow the contaminant processing fluid F to flow therethrough; and the heat insulating flow path 11c formed to surround the fluid transporting path 11a and configured to allow the heat insulation fluid H to flow therethrough. In addition, each of the spray nozzles 11 may be formed with a fluid discharge port 11d communicating with the fluid transporting path 11a at the one end portion thereof. The heat insulation fluid H may be one that is for preventing the contaminant processing fluid from being evaporated. For example, as shown, the fluid transporting path 11a is disposed in the center portion, and the heat insulating flow path 11c is disposed around the fluid transporting path 11a so that the paths may establish a concentric structure. Through a multi flow path structure, each of the spray nozzles 11 may place the contaminant processing fluid at the inner side thereof, thereby protecting same and block high heat from the outside to the same. Accordingly, problems such as evaporation of the contaminant processing fluid inside each of the spray nozzles may be effectively solved. In other words, since the exhaust gas at the rear end of the diffusion module portion directly connected to the gas turbine may have a relatively high temperature, there may be a problem such that the contaminant processing fluid inside each of the spray nozzles evaporates, and the like, even before being discharged, by the heat of the exhaust gas, but such problems may be smoothly solved using such a spray nozzle structure.

Each of the spray nozzles 11 may be formed in: a structure in which one end of the heat insulating flow path 11c is opened to a periphery of the fluid discharge port 11d as shown in FIG. 5(a); or a structure in which the heat insulation fluid H is allowed to circulate by flowing in and flowing out to an opposite side and one side, respectively, as shown in FIG. 5(b). Here, the heat insulation fluid H may be formed of a gas or a liquid, and when the heat insulation fluid H is the gas, a structure as shown in FIG. 5(a) may be more effective. That is, the gas such as air and the like may be used as the heat insulation fluid H, and heat may be effectively insulated so that the heat from the outside does not reach the inside of each of the spray nozzles by allowing the gas to be continuously passed through and discharged into the heat insulating flow path 11c. In addition, when the heat insulation fluid H is formed of the liquid such as water and the like, a flow path, through which the heat insulation fluid H enters and exits at the opposite side and the one side, respectively, of the heat insulating flow path 11c, is established as shown in FIG. 5(b), thereby being configured so that the heat insulation fluid H circulates inside the heat insulating flow path 11c and then is discharged. In particular, with such a structure, the liquid-phase contaminant processing fluid is sprayed with each of the spray nozzles 11 even without using a pressurized gas, which will be described later, thereby being effectively injected into the exhaust gas. However, the structure of each of the spray nozzles 11 of the present disclosure does not need to be limited as such, so other structures that may be applied as needed will be additionally described.

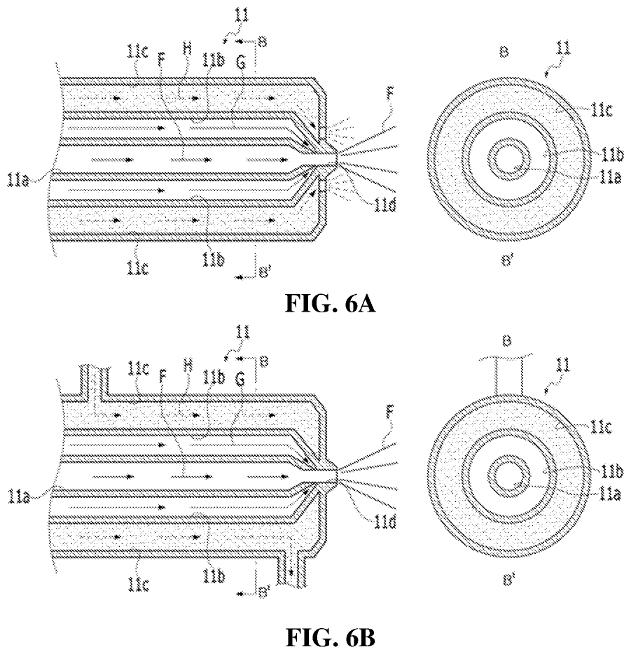

Meanwhile, as necessary, each of the spray nozzles 11 may further include a pressurized gas flow path 11b connected to the fluid discharge port 11d and configured to transport the pressurized gas G. In such a case, the contaminant processing fluid may be formed in foam in a form of fine particles, thereby even being sprayed by each of the spray nozzles 11. In this case, as shown in FIGS. 6(a) and 6(b), each of the spray nozzles 11 may include: the fluid transporting path 11a configured to flow the contaminant processing fluid F; the heat insulating flow path 11c configured to flow the heat insulation fluid H and formed to surround the fluid transporting path 11a; and the pressurized gas flow path 11b configured to flow the pressurized gas G. In addition, each of the spray nozzles 11 may be formed with a fluid discharge port 11d communicating with the fluid transporting path 11a and the heat insulating flow path 11c at the one end portion thereof. In other words, the pressurized gas flow path 11b may be disposed between the fluid transporting path 11a and the heat insulating flow path 11c, and the pressurized gas flow path 11b may be disposed around the periphery of the outer circumference of the fluid transporting path 11a as shown. For example, as shown, the fluid transporting path 11a is disposed in the center portion, and the pressurized gas flow path 11b and the heat insulating flow path 11c are sequentially arranged around the fluid transporting path 11a, so that the paths may establish a concentric structure.

Although not shown, the pressurized gas G or the heat insulation fluid H may be supplied by connecting the compressor and the supply line connected to the compressor with each of the spray nozzles 11. The heat insulation fluid H may be, for example, air or water, and the pressurized gas G may be, for example, compressed air. Meanwhile, the heat insulation fluid H may be a liquid or gas. When the heat insulation fluid H is formed of a gas, such a compressor may be utilized. When the heat insulation fluid H is a liquid, it may be used by connecting a circulation pump or the like.

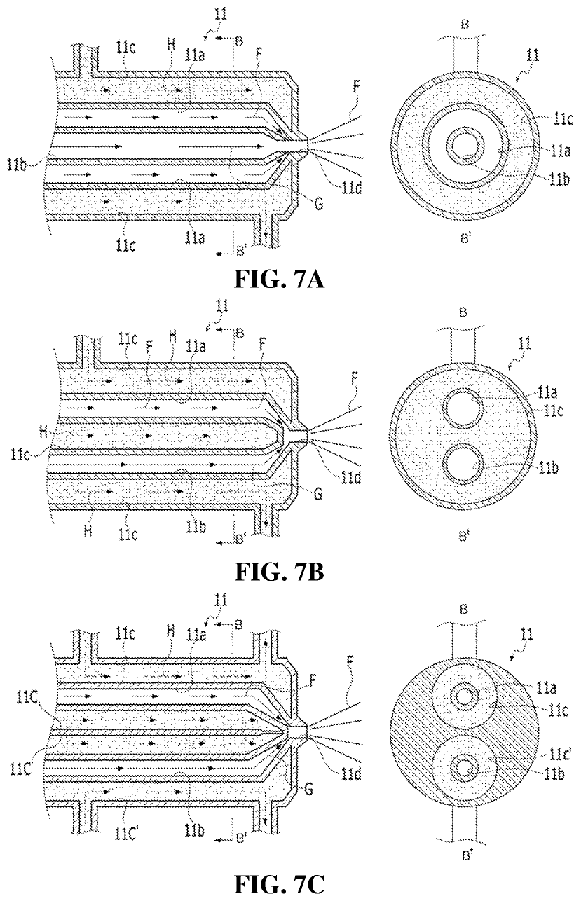

Each of the spray nozzles 11 may have various arrangements or structures of flow paths as shown in FIG. 7. For example, as shown in FIG. 7(a), the fluid transporting path 11a may be disposed around the periphery of the outer circumference of the pressurized gas flow path 11b. That is, the flow paths are formed in a concentric structure, wherein the pressurized gas flow path 11b is arranged in the center portion, the fluid transporting path 11a is arranged around the periphery of the outer circumference of the pressurized gas flow path 11b, and the heat insulating flow path 11c may be formed in a form surrounding the fluid transporting path 11a again. In addition, as shown in FIGS. 7(b) and 7(c), the paths may be formed in a shape other than a concentric structure. In this case, for example, as shown in FIG. 7(b), the pressurized gas flow path 11b is spaced apart from the fluid transporting path 11a, and the heat insulating flow path 11c may surround the pressurized gas flow path 11b too. That is, the heat insulating flow path 11c is not limited to a specific shape and widely uses the internal space of each of the spray nozzles, whereby it is possible to form the heat insulating flow path 11c in a shape surrounding the entire fluid transporting path 11a and the pressurized gas flow path 11b that are spaced apart. In addition, for example, as shown in FIG. 7(c), the pressurized gas flow path 11b is spaced apart from the fluid transporting path 11a and an additional heat insulating flow path 11c′ surrounding the pressurized gas flow path 11b may be formed. That is, using the inner space of each of the spray nozzles 11, the heat insulating flow path 11c and the additional heat insulation flow path 11c′, which surround the peripheries, respectively, of the outer circumferences of the fluid transporting path 11a and the pressurized gas flow path 11b that are separated from each other, may be formed, respectively. At this time, a structure configured to flow and circulate the heat insulation fluid H may be formed in the heat insulating flow path 11c and the additional heat insulating flow path 11c′, respectively. In this way, a spray nozzle structure, in which the contaminant processing fluid F, pressurized gas G, and heat insulation fluid H flow therein, may be formed in various shapes, and external high heat may be blocked by using the insulation fluid H inside each of the spray nozzles. Through this, it is possible to very effectively solve problems such as evaporation of the contaminant processing fluid inside each of the spray nozzles and the like.

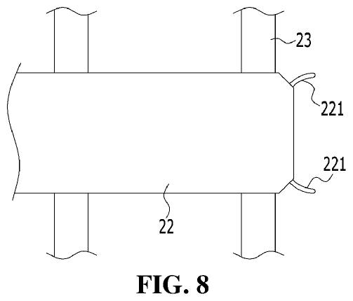

Hereinafter, a flow control member that may be formed in the hub will be described in more detail with reference to FIG. 8. Here, FIG. 8 is a view showing an example of a flow control member formed in the hub.

The above-described hub 22 may be formed with a flow control member 221 as shown in FIG. 8. That is, the flow control member 221 configured to induce a flow direction of the exhaust gas toward the inner wall of the duct 3 may be additionally formed in the hub 22. The flow control member 221 may be formed to strengthen a velocity component in the centrifugal direction at the rear end by inducing the exhaust gas flow and may be implemented in various forms. For example, the flow control member 221 may also be formed of a plate in a curved surface shape, a block-shaped structure in which a fluid guide surface is formed on the outer surface, or the like. Therefore, the illustrated flow control member 221 is only an example, and the flow control member 221 is not necessary to be understood as being limited thereto. The size, arrangement, and shape of the flow control member 221 may be appropriately changed in consideration of the exhaust gas flow.

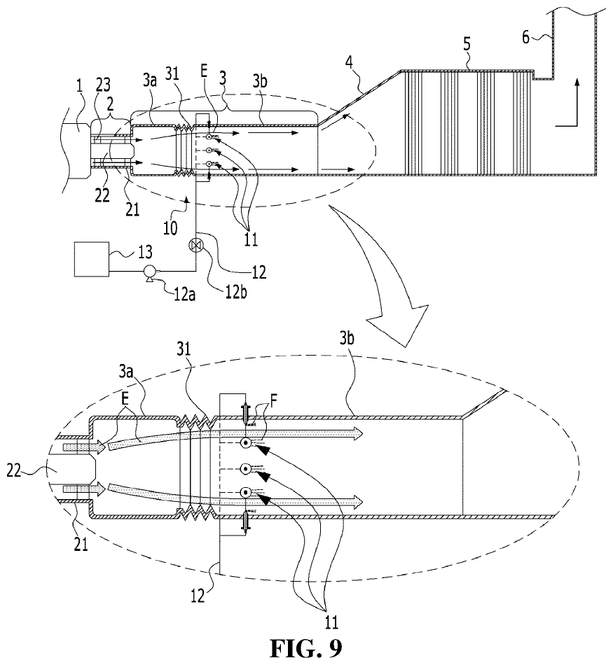

Hereinafter, an operation process of the exhaust gas processing device will be described with reference to FIG. 9. FIG. 9 is an operation diagram of the exhaust gas processing device of FIG. 1.

The exhaust gas processing device 10 of the present disclosure actuates as shown in FIG. 9. When the gas turbine 1 is driven, the exhaust gas E is discharged, and the flow thereof is adjusted while being passed through the diffusion module portion 2 that is at the rear stage of the gas turbine 1. That is, while passing through the diffusion module portion 2 as described above, the exhaust gas E acquires a centrifugal speed and is induced to the inner wall of the duct 3 that is at the rear end of the diffusion module portion 2. In particular, the hub 22 inserted into the center portion of the diffusion module portion 2 may make a radial flow toward the outer cylinder unit 21, thereby more effectively inducing the flow of the exhaust gas E toward the inner wall of the duct 3.

While the gas turbine 1 is being driven, the exhaust gas E is continuously induced toward the inner wall of the duct 3 through such a process, and thus, a high-concentration exhaust gas flow is formed along the inner wall of the duct 3. The contaminant processing fluid F is intensively injected into the flow of the exhaust gas E, which is induced to the inner wall of the duct 3 in such a way, by using the spray nozzles 11 protruding from the inner wall of the duct 3. The contaminant processing fluid F is supplied to the spray nozzles 11 through the fluid supply pipe 12 while having been stored in a liquid phase in the fluid supply portion 13 and then discharged to the one end portion of each of the spray nozzles 11, thereby being immediately injected into the exhaust gas E. In particular, since the fluid F for processing liquid-phase contaminants is intensively injected into the high-concentration flow of the exhaust gas E flowing at a high speed that is continuously induced to the inner wall of the duct 3, a mixing ratio of the contaminant processing fluid F and the exhaust gas E may be greatly increased. In addition, even without separately passing a process such as vaporizing the contaminant processing fluid F and the like, it may effectively process the contaminants by mixing the exhaust gas E and the contaminant processing fluid F. In addition, the contaminant processing fluid is intensively injected into the high-concentration flow of the exhaust gas E formed on the inner wall of the duct 3, thus significantly lowers the concentration of contaminants in the entire exhaust gas E, whereby the exhaust gas E discharged lastly may also become in accordance with emission standards. The exhaust gas processing device 10 of the present disclosure may induce the exhaust gas E processed as such to pass through the duct expansion pipe 4, the heat recovery boiler portion 5, and the stack 6 in turn, which are at the rear end of the duct 3, thereby recovering the remaining waste heat of the exhaust gas E and then discharging the exhaust gas E to the outside.

Hereinafter, the effects of the present disclosure will be described in more detail through several experimental examples. Hereinafter, in the description of each experimental example, the above-described components will be referred to and described without a separate reference numeral.

### <Experimental Example 1> Exhaust Gas Processing Experiment for Combined Cycle Power Station

An exhaust gas processing device as shown in FIG. 1 was installed in a combined cycle power station, and NO₂ concentration in the stack was measured while an ethanol-based liquid-reducing agent was injected in an amount of 300 L/hr using spray nozzles. At this time, the position of the spray nozzles in the duct was made to be such that a distance from the hub to the position of the spray nozzles corresponds to ⅜ of the aforementioned straight-line distance ‘c’, and the position of the one end portion of each of the spray nozzles was made to be such that a distance from the inner wall of the duct to the position of the one end portion of each of the spray nozzles corresponds to ⅙ of the aforementioned vertical line ‘a’.

The injection of the liquid-reducing agent was started simultaneously with the ignition of the gas turbine, and the change in the output of the gas turbine according to the time change after the gas turbine ignition was also measured. The gas turbine was operated under the same conditions, and the NO₂ concentration in the stack before injection of the reducing agent and the NO₂ concentration in the stack after injection of the reducing agent were measured and compared, at the same timeslots. Table 1 shows the measurement results.

TABLE 1
Change of NO₂ concentrations of stack before
and after injection of reducing agent

| | Time after ignition of gas | | | | | | | |
|---|---|---|---|---|---|---|---|---|
| | turbine (Minute) | | | | | | | |
| | 5 | 10 | 20 | 30 | 50 | 70 | 90 | 100 |
| Gas turbine output (MW) | 0 | 28 | 32 | 33 | 32 | 33 | 39 | 60 |
| NO₂ concentration in stack | 16 | 41 | 46 | 49 | 51 | 32 | 48 | 28 |
| before reducing agent | | | | | | | | |
| injection (ppm) | | | | | | | | |
| NO₂ concentration in stack | 3 | 1 | 0 | 0 | 1 | 0 | 1 | 1 |
| after reducing agent injection | | | | | | | | |
| (ppm) | | | | | | | | |

As shown in Table 1, the NO₂ concentration in the stack after the injection of the reducing agent was 0-3 ppm, regardless of the operating time, indicating a concentration at which no yellow gas could be observed. Therefore, it may be seen that the present disclosure may effectively process the yellow gas and the like, which may be particularly problematic in a combined cycle power station. In particular, it may be seen that it is possible to process the yellow gas (including the yellow gas that may be temporarily observed depending on a weather condition) even at the beginning of the gas turbine start-up. In addition, it may be seen that the present disclosure may easily process contaminants even under operating conditions in which contaminant processing is difficult because it is difficult to evenly disperse the processing fluid by vaporization. This is considered to be because the contaminant processing fluid in the duct is smoothly mixed with the object to be processed according to the present disclosure. Hereinafter, by checking the change in the distribution of the contaminant processing fluid according to the change in the position of the spray nozzles and the position of the one end portion of each of the spray nozzles, in the duct, it was tried to confirm the effect of the changes on the mixing and the resulting effect of the changes on the exhaust gas processing.

### <Experimental Example 2> Confirmation of Distribution Change of the Contaminant Processing Fluid at Rear End of Duct According to Changes in Position of Spray Nozzles in Duct

An experiment was conducted as follows to confirm the change in the mixing distribution of the contaminant processing fluid according to the changes in the position of the spray nozzles in the duct. Ammonia water was sprayed with the spray nozzles inside the duct as shown in FIGS. 1 to 4, and the concentration distribution of ammonia was measured at the duct expansion pipe side connected to the rear end of the duct. At this time, air, which simulates the fluid condition flowing out of the gas turbine when the gas turbine is started up, was injected from the location of the gas turbine. The spray nozzles were arranged as shown in FIG. 2 on the cross section of the duct, wherein the experiment was conducted by increasing the distance spaced apart from the hub at a constant ratio to the straight-line distance ‘c’ in FIG. 4 along the longitudinal direction of the duct. The position of the one end portion of each of the spray nozzles was maintained such that a distance from the inner wall of the duct to the position of the one end portion of each of the spray nozzles corresponds to 3/6 of the aforementioned vertical line ‘a’. A hole accessible into the duct is formed at the end of the duct expansion pipe (the point where the duct expansion pipe and the heat recovery boiler portion 5 are connected), and by inserting detection devices through the hole, ammonia concentration was measured at a total of 9 points at the upper 3 points, the center 3 points, and the lower 3 points of a right end of the duct expansion pipe. From the measurement results, as shown in Table 1 below, an average concentration and a standard deviation for the upper 3 points and, an average concentration and a standard deviation for the center 3 points, an average concentration and a standard deviation for the lower 3 points, and an average concentration and a standard deviation for the total of all 9 points were calculated. The ammonia water sprayed from the spray nozzles was adjusted so that an ammonia concentration was 7±1 ppm as the theoretical value in the measurement part. As a result, results were obtained as shown in Table 2 below.

TABLE 2
Distribution change of contaminant processing fluid at rear end of duct according
to position changes of spray nozzles in duct (concentration unit is ppm)

| position of | | | | | | | | |
|---|---|---|---|---|---|---|---|---|
| spray nozzles | average | standard | average | standard | average | standard | average | standard |
| in duct (ratio | concentration | deviation | concentration | deviation | concentration | deviation | concentration | deviation |
| to straight- | for total | for total | for lower | for lower | for center | for center | for upper | for upper |
| line ‘c’) | points | points | points | points | points | points | points | points |
| 1/8 | 7.3 | 0.9 | 8.0 | 0.8 | 6.7 | 0.9 | 7.3 | 0.5 |
| 2/8 | 7.0 | 1.1 | 8.0 | 0.0 | 6.0 | 0.8 | 7.0 | 0.8 |
| 3/8 | 7.3 | 1.3 | 7.7 | 0.5 | 7.3 | 1.7 | 7.0 | 1.4 |
| 4/8 | 7.2 | 1.2 | 8.0 | 0.0 | 7.0 | 0.8 | 6.7 | 1.7 |
| 5/8 | 7.3 | 1.9 | 8.3 | 0.5 | 7.7 | 1.2 | 6.0 | 2.4 |
| 6/8 | 7.4 | 2.1 | 7.7 | 1.7 | 9.3 | 1.2 | 5.3 | 0.5 |
| 7/8 | 7.3 | 2.6 | 6.7 | 1.2 | 10.7 | 0.5 | 4.7 | 0.5 |
| 8/8 | 7.4 | 4.3 | 9.0 | 2.2 | 11.3 | 1.7 | 2.0 | 0.8 |

As shown in Table 2, when the position of the spray nozzles is such that a distance from the hub to the position of the spray nozzles exceeds ⅞ of the straight-line distance ‘c’, it was confirmed that the standard deviation for the total nine points increased significantly. Therefore, in such a case, it may be expected that the contaminant processing fluid may not be uniformly mixed into the exhaust gas. This may be interpreted as being due to the large difference between the average concentration for the lower side, the average concentration for the center, and the average concentration for the upper side. Therefore, it may be seen that the position of the spray nozzles in the duct may be better to be within ⅞ of the straight-line distance ‘c’ from the hub. In particular, the uniform mixing of the contaminant processing fluid and the exhaust gas has no choice but to directly affect the processing rate of the exhaust gas. Therefore, by allowing the position of the spray nozzles in the duct to be within ⅞ of the straight-line distance ‘c’ from the hub, it may be seen that uniform mixing of the exhaust gas and the contaminant processing fluid is induced and stable processing of the exhaust gas is also possible.

### <Experimental Example 3> Confirmation of Distribution Change of Contaminant Processing Fluid, at Rear End of Duct, According to Change in Position of One End Portion of Each of Spray Nozzles

An experiment was conducted as follows to confirm the change in the distribution of the contaminant processing fluid according to the changes in the position of the one end portion of each of the spray nozzles. Specifically, among the conditions of Experimental Example 2, the position of the spray nozzles in the duct is fixed to be at ⅜ with respect to the straight-line distance ‘c’ from the hub, and then the experiment was conducted in a manner that the position of the one end portion of each of the spray nozzles is changed at a certain ratio with respect to the vertical line ‘a’. The ammonia water sprayed from the spray nozzles was adjusted so that an ammonia concentration was 8±1 ppm as the theoretical value in the measurement part, and the rest of the experimental conditions were the same as in Experimental Example 2. From this, results were obtained as shown in Table 3 below.

TABLE 3
Distribution change of contaminant processing fluid at rear end of duct according to position
changes of one end portion of each of spray nozzles in duct (concentration unit is ppm)

| position of | | | | | | | | |
|---|---|---|---|---|---|---|---|---|
| spray nozzles | average | standard | average | standard | average | standard | average | standard |
| in duct (ratio | concentration | deviation | concentration | deviation | concentration | deviation | concentration | deviation |
| to vertical | for total | for total | for lower | for lower | for center | for center | for upper | for upper |
| line ‘a’) | points | points | points | points | points | points | points | points |
| 1/6 | 8.3 | 1.7 | 7.7 | 0.9 | 9.3 | 1.2 | 8.0 | 2.2 |
| 2/6 | 8.0 | 1.3 | 8.7 | 0.9 | 8.3 | 0.9 | 7.0 | 1.4 |
| 3/6 | 8.4 | 1.1 | 8.0 | 0.8 | 9.0 | 0.8 | 8.3 | 1.2 |
| 4/6 | 8.4 | 1.2 | 8.0 | 0.0 | 8.3 | 1.7 | 9.0 | 0.8 |
| 5/6 | 8.3 | 2.6 | 7.7 | 1.2 | 11.3 | 1.2 | 6.0 | 1.6 |
| 6/6 | 8.4 | 5.0 | 8.7 | 1.2 | 14.3 | 0.9 | 2.3 | 0.5 |

As shown in Table 3, when the position of the one end portion of each of the spray nozzles is at a position that exceeds ⅚ with respect to the vertical line ‘a’ from the inner wall of the duct, it was confirmed that the standard deviation for the total nine points increased significantly. Therefore, in such a case, it may be expected that the contaminant processing fluid may not be uniformly mixed into the exhaust gas. This may be interpreted as being due to the large difference between the average concentration for the lower side, the average concentration for the center, and the average concentration for the upper side. Therefore, it may be seen that the position of the one end portion of each of the spray nozzles may be better to be within ⅚ of the vertical line distance ‘a’ from the inner wall of the duct. In particular, the uniform mixing of the contaminant processing fluid and the exhaust gas has no choice but to directly affect the processing rate of the exhaust gas.

Therefore, by allowing the position of the one end portion of each of the spray nozzles to be within ⅚ of the vertical line distance ‘a’ from the inner wall of the duct, it may be seen that uniform mixing of the exhaust gas and the contaminant processing fluid is induced and stable processing of the exhaust gas is also possible.

Summarizing the results of Experimental Examples 2 and 3, it may be seen that the exhaust gas processing is more effective when the positions, of the spray nozzles in the duct and the one end portion of each of the spray nozzles, are each within, from the hub, ⅞ of the straight-line distance ‘c’ and within, from the inner wall of the duct, ⅚ of the vertical line ‘a’.

Although the embodiments of the present invention have been described with reference to the accompanying drawings, those of ordinary skill in the art to which the present disclosure pertains may understand that it may be implemented in other specific forms without changing the technical spirit or essential features. Therefore, it should be understood that the embodiments described above are illustrative and non-limiting in all respects.

### DESCRIPTION OF THE REFERENCE NUMERALS IN THE DRAWINGS

| | |
|---|---|
| 1: gas turbine | 2: diffusion module portion |
| 3: duct | 3a: first duct portion |
| 3b: second duct portion | |
| 4: duct expansion pipe | |
| 5: heat recovery boiler portion | |
| 6: stack | |
| 10: exhaust gas processing device | |
| 11: spray nozzle | |
| 11a: fluid transporting path | 11b: pressurized gas flow path |
| 11c: heat insulating flow path | 11c′: additional heat insulating |
| | flow path |
| 11d: fluid discharge port | |
| 12: fluid supply pipe | |
| 12a: pump | 12b: control valve |
| 13: fluid supply portion | |
| 21: outer cylinder portion | |
| 22: hub | 23: support |
| 31: buffer connection | 32: accommodation groove |
| 111: body | 112: coupling flange |
| 113: gasket | 114: flanged pipe |
| 221: flow control member | |
| E: exhaust gas | |
| F: contaminant processing fluid | |
| G: pressurized gas | H: heat insulation fluid |

### INDUSTRIAL APPLICABILITY

The present disclosure may be used to very effectively and efficiently process the exhaust gas of a thermal power station. In addition, the present disclosure has an advantage of excellently processing the exhaust gas generated and discharged from a combined thermal power station, and thus has the potential for industrial use.

1. An exhaust gas processing device for a thermal power station, the exhaust gas processing device comprising:
a diffusion module portion configured to adjust an exhaust gas flow, between a duct disposed on a rear end of a gas turbine of a thermal power station and the gas turbine, thereby inducing same toward an inner wall of the duct;
a plurality of spray nozzles installed in a flow section, inside the duct, of an exhaust gas induced from the diffusion module portion toward the inner wall of the duct and protrudingly formed from the inner wall of the duct;
a fluid supply pipe connected to the spray nozzles and being extended to the outside of the duct; and
a fluid supply portion configured to supply liquid-phase contaminant processing fluid to the spray nozzles through the fluid supply pipe,
wherein the diffusion module portion comprises:
an outer cylinder portion configured such that the exhaust gas passes through the interior thereof; and
a hub inserted into a center portion of the outer cylinder portion so as to induce the exhaust gas in a centrifugal direction, and
the spray nozzles do not intersect with an extension line extending in a longitudinal direction of the hub from an outer circumferential surface of the hub.

2. The exhaust gas processing device of claim 1, wherein each of the spray nozzles is coupled penetrating through the duct and has one end portion located inside the duct and an opposite end portion exposed to the outside of the duct.

3. The exhaust gas processing device of claim 2, wherein each of the spray nozzles is inserted into the inside of a flanged pipe penetrating through the duct and having a flange formed at an outside of the duct, and is fixed by being in contact with the flange at at least a part thereof.

4. The exhaust gas processing device of claim 2, wherein the fluid supply pipe is connected to the opposite end portion of each of the spray nozzles, exposed to the outside of the duct.

5. The exhaust gas processing device of claim 1, wherein the duct is a polygonal duct having a cross section in a polygonal shape formed by connecting different inner walls in a planar shape from which the spray nozzles protrude.

6. The exhaust gas processing device of claim 5, wherein the spray nozzles are arranged such that at least one thereof is on each of a plurality of different inner walls of the duct.

7. The exhaust gas processing device of claim 1, further comprising a flow control member configured to induce a flow direction of the exhaust gas toward the inner wall of the duct at the hub.

8. The exhaust gas processing device of claim 1, wherein, one end portion of each of the spray nozzles is spaced apart by no more than ⅚ of a length of a vertical line ‘a’ from the inner wall of the duct, along the vertical line ‘a’, wherein the vertical line ‘a’ is drawn downwards from an extension line to the inner wall of the duct, wherein the extension line is parallelly extended from an outer circumferential surface of the hub in the longitudinal direction of the hub.

9. The exhaust gas processing device of claim 1, wherein each of the spray nozzles is spaced apart from an intersection of a first extension line and a second extension line, along the first extension line, by no more than ⅞ of a straight-line distance ‘c’, wherein the first extension line parallelly extends in a longitudinal direction of the duct on the inner wall of the duct, the second extension line extends from a right end of the hub and perpendicularly intersects with the first extension line, and the straight-line distance ‘c’ is a length from the hub to the duct expansion pipe connected to a rear end of the duct.

10. The exhaust gas processing device of claim 1, wherein the duct comprises
a buffer connection portion, configured to buffer a vibration, on one side, and
the spray nozzles are located at a rear end of the buffer connection portion.

11. The exhaust gas processing device of claim 1, wherein each of the spray nozzles comprises:
a fluid transporting path connected to a fluid discharge port and configured to transport the contaminant processing fluid; and
a heat insulating flow path not connected to the fluid discharge port, surrounding the fluid transporting path, and configured to accommodate a heat insulation fluid.

12. The exhaust gas processing device of claim 11, wherein each of the spray nozzles further comprises a pressurized gas flow path connected to the fluid discharge port and configured to transport a pressurized gas.
